(19) United States
(12) Patent Application Publication
(10) Pub. No.: US 2013/0180476 A1
(43) Pub. Date: Jul. 18, 2013

(54) ENGINE AND ENGINE WORKING MACHINE

(71) Applicant: Hitachi Koki Co., Ltd., Tokyo (JP)

(72) Inventor: Naoto Ichihashi, Ibaraki (JP)

(73) Assignee: HITACHI KOKI CO., LTD., Tokyo (JP)

(21) Appl. No.: 13/742,167

(22) Filed: Jan. 15, 2013

(30) Foreign Application Priority Data
Jan. 17, 2012 (JP) 2012-007575

(51) Int. Cl. F02B 63/02

(52) U.S. Cl. CPC F02B 63/02
USPC 123/2

(57) ABSTRACT

A portable engine configured to operate a working machine includes: an engine body mainly configured by a crankcase and a cylinder; a carburetor connected to an inlet port of the cylinder; an air cleaner connected to the carburetor to filter suction air; a cleaner box configured to accommodate the air cleaner; and a fuel tank configured to store fuel which is supplied to the cylinder, wherein at least a part of the fuel tank is located between the cleaner box and the engine body.

This application claims priority from Japanese Patent Application No. 2012-007575 filed on Jan. 17, 2012, the entire subject matter of which is incorporated herein by reference.

### TECHNICAL FIELD

The present invention relates to an improvement in an engine which is mainly used as a power source of an engine working machine, and more specifically, to an engine working machine in which the shape and arrangement of a fuel tank are improved.

### BACKGROUND

In a working machine such as a bush cutter, a blower, a hedge trimmer, a chain saw and a cutter, a small engine is often used as a power source. Since such an engine working machine is often used while being carried outdoors or pressed by a user, a demand for miniaturization has been further increased. Further, since noise may be a problem in densely populated area such as urban areas, a demand for low noise has been further increased. Generally, the engine used as the power source of the engine working machine has a high-density structure in which devices to be driven such as a tip tool, a cooling fan and a manual starting device are provided at a driving shaft (crankshaft) and therefore a large number of parts are arranged adjacent to the engine. Accordingly, in order to balance the miniaturization and the low-noise, a configuration that the size of an air cleaner room and a muffler is increased and a fuel tank is moved forward has been proposed in JP-A-5-47374.

### SUMMARY

In JP-A-5-47374, it is intended to reduce exhaust noise by increasing the size of the air cleaner room and the muffler. However, as the size of the air cleaner room and the muffler is increased, the size of the engine working machine itself is also increased. Consequently, there is a problem that portability may be degraded.

Therefore, one object of the present invention is to provide an engine and an engine working machine which are capable of suppressing the overall size of the machine to the same size as the above-described related-art example while increasing the size of the muffler or the air cleaner room.

Another object of the present invention is to provide an engine and an engine working machine which are capable of increasing the mounting density by improving the shape of a fuel tank.

Still another object of the present invention is to provide an engine and an engine working machine which are capable of effectively utilizing a dead space by improving arrangement relationship between the fuel tank and the air cleaner room.

According to one illustrative aspect of the present invention, there is provided an engine configured to operate a working machine, the engine comprising: an engine body comprising a crankcase and a cylinder; a carburetor connected to an inlet port of the cylinder; an air cleaner connected to the carburetor to filter suction air; a cleaner box configured to accommodate the air cleaner; and a fuel tank configured to store fuel which is supplied to the cylinder, wherein at least a part of the fuel tank is located between the cleaner box and the engine body.

According thereto, by forming at least a part of the fuel tank at a location between the cleaner box and the engine body, it is possible to realize an engine which is capable of suppressing the overall size of the machine to the same size as the related-art example while increasing the size of the muffler or the air cleaner room.

According to another illustrative aspect of the invention, there is provided an engine working machine comprising the engine according to the above illustrative aspect.

According thereto, it is possible to provide the engine working machine which is compact and is easy to use. Further, the engine working machine can be operated in a quiet operation sound.

### BRIEF DESCRIPTION OF THE DRAWINGS

FIG. 1 is a side view of an engine working machine according to an exemplary embodiment of the present invention;

FIG. 2 is a side view of the engine working machine according to the exemplary embodiment of the present invention, showing a state where a cleaner cover 32 is removed from the engine working machine;

FIG. 3 is a longitudinal sectional view of the engine working machine according to the exemplary embodiment of the present invention, showing a cross-sectional shape of II-II part of FIG. 2;

FIG. 4 is a side view of the engine working machine according to the exemplary embodiment of the present invention, explaining arrangement relationship among an engine, an air cleaner room and a fuel tank;

FIG. 5 is a rear view of an engine working machine according to a second exemplary embodiment of the present invention;

FIG. 6 is a side view of the engine working machine 101 according to the second exemplary embodiment of the present invention.

FIG. 7 is a longitudinal sectional view of the engine working machine 101 according to the second exemplary embodiment of the present invention, showing a cross-sectional shape of VII-VII part of FIG. 6.

FIG. 8 is a side view of the engine working machine 101 according to the second exemplary embodiment of the present invention, explaining arrangement relationship among an engine, an air cleaner room and a fuel tank.

### DETAILED DESCRIPTION OF THE PREFERRED EMBODIMENTS

### First Exemplary Embodiment

Hereinafter, exemplary embodiments of the present invention will be described with reference to the accompanying drawings. In the following drawings, the same or similar reference numerals are applied to the same or similar parts and elements, and the duplicated description thereof will be omitted. Further, as used herein, a front-rear direction and an upper-lower direction are referred to the directions indicated in the drawings. As used herein, the engine is interpreted as a concept to include auxiliary devices such as a crankcase, a cylinder, a carburetor, a muffler and a fuel tank, which are necessary for operation of the engine. Further, an engine body refers to a body in a state where the auxiliary devices such as the carburetor, the muffler and the fuel tank are removed from the engine.

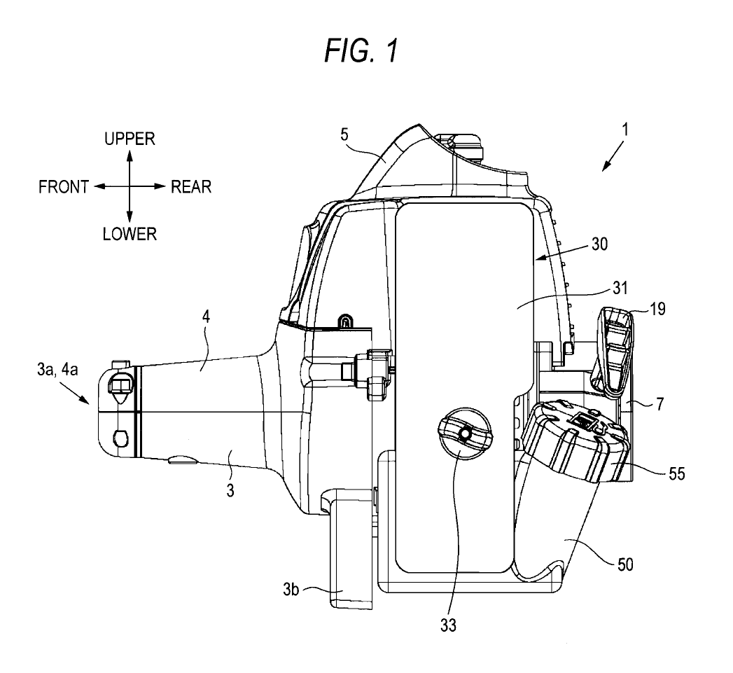

FIG. 1 is a side view of an example where the engine working machine 1 according to the exemplary embodiment of the present invention is applied to a bush cutter. In the engine working machine 1, the engine (not shown) is accommodated in a resin volute case (an upper volute case 4, a lower volute case 3) and the carburetor (not shown) is provided at a left side portion of the engine. Air for combustion is sucked to the carburetor via the air cleaner which filters dust in the air. The air cleaner is accommodated in a cleaner box 30 having a given closed space (air cleaner room). A part of the air cleaner room is covered with a cleaner cover 32. A fuel tank 50 which stores fuel for running the engine is provided below the lower volute case 3. The fuel tank 50 is manufactured by integral molding of polymeric resin such as plastic, for example. Further, the fuel tank 50 is manufactured by a translucent material so that a remaining amount of fuel is visible from the outside. A fuel cap 55 is provided at an opening of the fuel tank. Since a two-cycle engine is used in the present exemplary embodiment, fuel into which oil for lubrication is mixed in a predetermined ratio, so called a “mixed oil” may be contained in the fuel tank 50.

In the engine which is not shown in the drawings, the cylinder (not shown) is vertically arranged and a piston (not shown) vertically reciprocates in the cylinder. The crankcase (not shown) to which the cylinder is attached is held by the upper volute case 4 and the lower volute case 3 and a cylinder part is covered with an upper cover 5. Cylindrical mounting parts 3a, 4a are formed at an output shaft side of the front of the engine working machine 1. The cylindrical mounting parts 3a, 4a extends forward to cover a drive shaft (not shown) on which the upper volute case 4 and the lower volute case 3 are mounted to cover an output transmission mechanism. The drive shaft (not shown) is mounted at a leading end of the cylindrical mounting parts 3a, 4a. Leg parts 3b are provided below the lower volute case 3 and serve as a support part when the engine working machine 1 is laid on a floor.

The cleaner box 30 forms a given space (air cleaner room) so that effective filtration is carried out by the air cleaner (will be described later) and suction noise can be sufficiently reduced. Accordingly, the cleaner box 30 is shaped to have a sufficiently large volume according to the displacement volume of the engine. In the present exemplary embodiment, an upper end of the cleaner cover 32 is substantially the same position as an upper end of the cylinder (not shown) and a lower end thereof extends to a position lower than a lower end of the crankcase of the engine. In this way, the volume of the air cleaner room is sufficiently secured. An operator can remove the cleaner cover 32 by loosening a cleaner knob 33 to access interior of the air cleaner room.

A recoil starter (not shown) is provided at a rear end side of the volute case. A known recoil starter may be used. The recoil starter is a manual starter in which the engine is started by connecting a reel to which a traction string is wound to a crankshaft of the engine via a clutch and by pulling the traction string. The recoil starter is covered with a starter cover 7. The starter cover 7 is provided with a starter knob 19 which is connected to a leading end of the traction string.

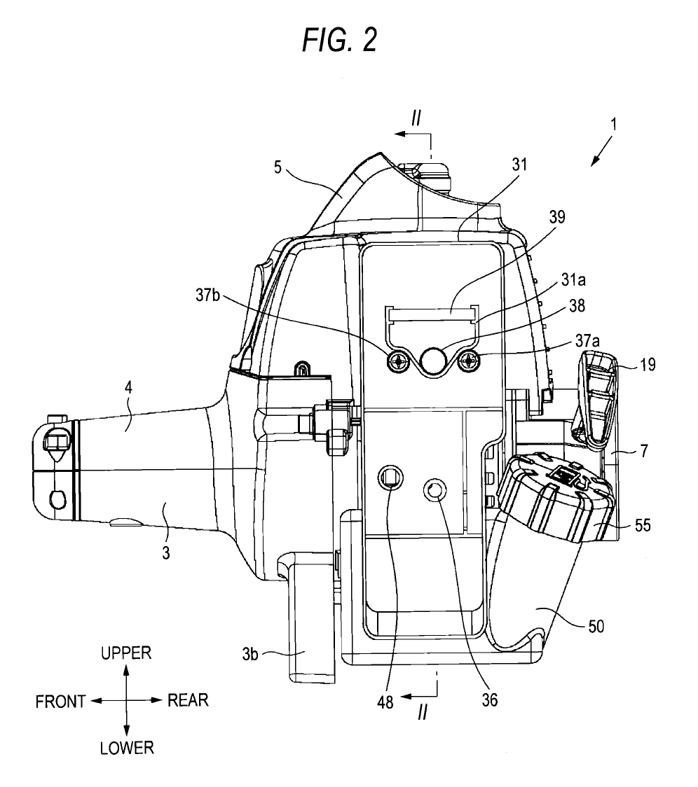

FIG. 2 is a side view of the engine working machine 1 according to the exemplary embodiment of the present invention, showing a state where the cleaner cover 32 is removed from the engine working machine. The cleaner box 30 for partitioning the air cleaner room mainly includes a cleaner body 31 and the cleaner cover 32 which closes an opening of the cleaner body. A carburetor (will be described later) is attached to an intake 38 of the engine (not shown). The intake 38 is opening to the air cleaner room. The cleaner body 31 is mounted together with the carburetor on an insulator by two fixing screws 37a, 37b. The cleaner cover 32 is mounted by tightening a male thread of the cleaner knob 33 with a female thread of a screw boss 36 which is provided at the cleaner body 31. The cleaner body 31 is provided with the intake 38 connected to the carburetor and an external air intake 48 having a circular opening. The circular opening is intended to receive suction air of the engine working machine 1. A filter support part 31a is formed around the intake 38 and a filter element 39 is provided at an upper portion of the filter support part 31a.

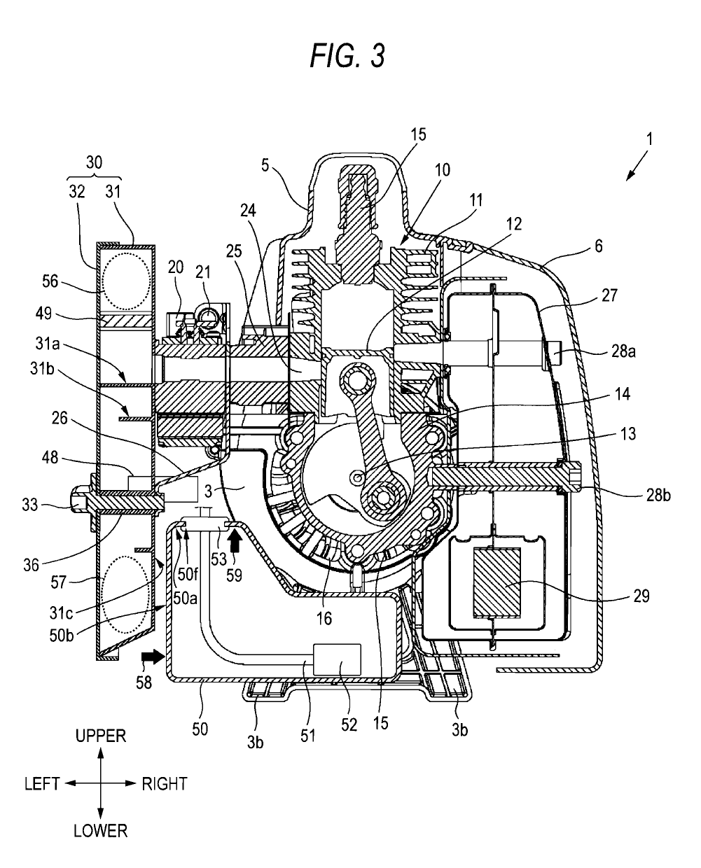

FIG. 3 is a cross-section view of “III-III” part of the FIG. 2. An engine body 10 is a small two-cycle single-cylinder engine. A piston 12 is connected to a crankshaft 13 via a connecting rod. The piston 12 reciprocates up and down inside a cylinder 11. The cylinder 11 is formed with an inlet port 24 for sucking air-fuel mixture for combustion. Inhalation-compression-explosion-exhaust strokes of the engine are the same as a known two-cycle engine and thus a detailed description thereof is omitted. In the present exemplary embodiment, the cylinder 11 includes a cylinder body, a head part and a radiating fin, which are integrally cast by an aluminum alloy, for example. An ignition plug 15 is mounted to an upper portion of the cylinder 11. High-voltage current is supplied to the ignition plug 15 at a given timing from an ignition device (not shown).

The upper cover 5 is a plastic cover, for example, and covers the cylinder 11 to prevent an operator from directly touching the cylinder. Here, the cylinder 11 becomes hot during operation. Accordingly, the upper cover 5 is formed with a plurality of vents. The engine body 10 is provided with a carburetor 20. The carburetor 20 is provided with a throttle wire mounting part to which a throttle wire is fixed. Further, the cleaner box 30 is provided at a left side of the carburetor 20. A muffler 27 is provided at a side of the cylinder 11 which is opposite to the cleaner box 30. The muffler 27 has a substantially rectangular parallelepiped basic shape and is arranged so that a longitudinal direction thereof corresponds to the vertical direction (up-down direction). This is possible because the volume of the muffler 27 is ensured as large as possible by increasing the size thereof in a longitudinal direction, in order to effectively reduce exhaust sound in a limited space. The muffler 27 is directly fixed to the cylinder 11 and the crankcase 14 of the engine body 10 by muffler fastening bolts 28a, 28b.

The fuel tank 50 is disposed at a lower side of the crankcase 14. Fuel is sucked into the carburetor 20 through a fuel hose 51 which is connected to the interior of the fuel tank 50 via a through-hole 50f. The fuel hose 51 is provided at its leading end with a filter 52 to prevent suction of dust. A rubber bush 53 for preventing leakage of the fuel is provided between the fuel hose 51 and the through-hole 50f of the fuel tank 50.

In an related-art engine working machine, the fuel tank 50 is located below the crankcase 14 and often has a flat shape which is bilaterally symmetrical with respect to a lateral center plane of the engine body 10. This is intended to prevent collapse of left and right weight balances of the engine working machine 1 due to the weight of the fuel such as mixed gasoline stored in the fuel tank 50 and also to suppress the height of the engine working machine. However, the present exemplary embodiment has a configuration that the muffler 27 is large in the vertical direction as compared to a muffler of the related-art engine working machine and thus extends to a lower side at which a fuel tank of the related-art engine working machine is located. Accordingly, in the present exemplary embodiment, a space (a space located in the vicinity of a catalyst 29) which is occupied by the muffler 27 extending downward is ensured by offsetting the position of the fuel tank 50 to the left. That is, according to the present exemplary embodiment, the muffler 27 is provided at the side of the engine body 10 which is opposite to the side where the carburetor 20 is provided, the muffler 27 is configured to cover side surfaces of the cylinder 11 and the crankcase 14 and is sized to extend lower than the lowermost point of the crankcase 14, and most of the fuel tank 50 is disposed at a space between the muffler 27 and the cleaner box 30. According thereto, the fuel tank 50 does not protrude outward from the muffler 27 and the cleaner box 30, and it is possible to realize an engine having a compact and clean appearance. Further, since the lowermost point of the fuel tank 50 is positioned below the lowermost point of the muffler 27, the fuel tank 50 can be used as a portion of the leg parts.

Further, in the present exemplary embodiment, the cleaner box 30 is extended upward and thus the size thereof is increased, so that a space in the vicinity of dotted line 56 is ensured. Further, the cleaner box 30 is extended downward and thus the size thereof is increased, so that a space in the vicinity of dotted line 57 is ensured. As a result, the capacity of the cleaner box 30 is increased. Typically, the thickness (lateral distance in the drawings) of the air cleaner room may be increased in order to increase the volume of the cleaner box 30. However, if the thickness of the air cleaner room is increased, the size of the engine working machine 1 in the lateral direction is increased and therefore it is difficult to use this engine working machine as a portable engine working machine. Accordingly, in the present exemplary embodiment, the cleaner box 30 is stretched in the vertical direction by enlarging the size thereof in an up-down direction and further stretched in the lateral direction (cylindrical tangential direction of the cylinder), while maintaining the thickness of the air cleaner room to be equivalent to a related-art air cleaner room. In this way, a sufficient volume is ensured and thus an intake sound is reduced. That is, the cleaner box 30 has a flat shape which extends in the vertical direction and the tangential direction of the cylinder 11. Therefore, it is possible to realize a compact engine while suppressing the protrusion amount thereof protruding toward the side of the cylinder 11. Further, the capacity of the air cleaner room can be sufficiently secured and thus an engine capable of suppressing suction noise can be realized.

However, the enlargement of the cleaner box 30 in the up-down direction affects a space to accommodate the fuel tank 50. Accordingly, in the present exemplary embodiment, a left wall 50b of the fuel tank 50 is shrunk in the right direction as indicated by arrow 58 so as to be located to the right than a right end surface 31c of the cleaner body 31. Further, an upper wall 50a of a portion of the fuel tank 50 is moved upward as indicated by arrow 59 and thus interposed between the cleaner box 30 and the crankcase 14. In this way, the capacity of the fuel tank 50 is ensured. That is, in the present exemplary embodiment, the uppermost position of the fuel tank 50 is located above a lowermost point of the crankcase 14 and also above a lowermost point of the cleaner box 30, and a lowermost position of the fuel tank 50 is located below the lowermost point of the cleaner box 3. Therefore, it is possible to realize an engine which includes a compact fuel tank 50 capable of effectively utilizing the space around the crankcase 30. Although details will be described later, a front wall of the fuel tank 50 is moved to the front and the enlargement part thereof extends to a space which is located below the carburetor 20 and sandwiched by the crankcase 14 and the cleaner box 30. In this way, a tank capacity substantially the same as the related-art fuel tank is ensured without increasing the overall size of the engine working machine 1. In this manner, in the present exemplary embodiment, the shape of the fuel tank 50 is changed to effectively utilize a space around the engine body 10. However, since the fuel tank 50 is arranged at a position as close as possible to the crankcase 14, a weight balance is hardly collapsed and thus it is possible to realize an engine working machine having a good weight balance. Incidentally, a heat shield plate 26 is provided between the carburetor 20 and the cleaner box 30, and an insulator 25 to block heat from the engine body 10. However, heat between the crankcase 14 and the fuel tank 50 may be blocked by increasing the size of the heat shield plate 26 or providing a heat shield plate separate from the heat shield plate 26.

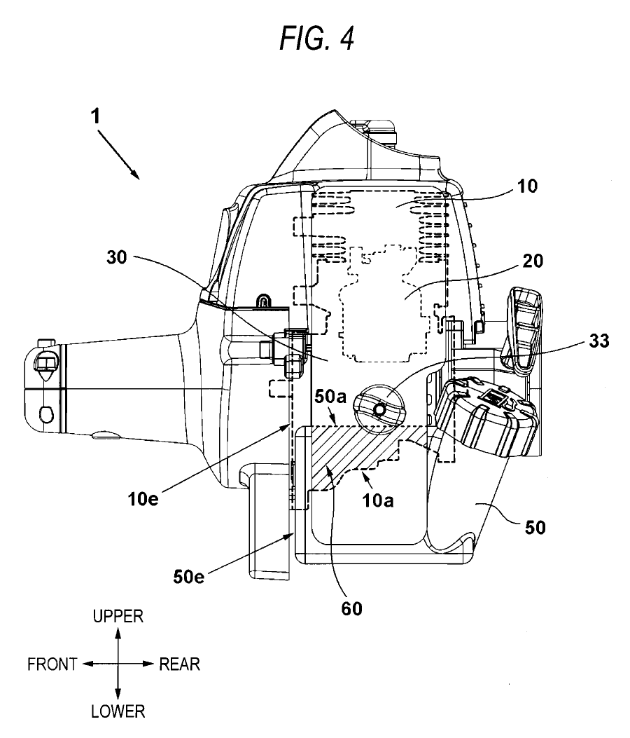

FIG. 4 is a side view of the engine working machine 1 according to the present exemplary embodiment, explaining arrangement relationship among the engine body 10, the cleaner box 30 and the fuel tank 50. A front wall 50e of the fuel tank 50 is configured to extend to the front side than the cleaner box 30 and the upper wall 50a of the fuel tank 50 is formed at a position near the cleaner knob 33. The position of the engine body 10 is arranged as indicated by dotted line and thus the engine body 10, the cleaner box 30 and the fuel tank 50 are arranged to be overlapped at a shaded portion 60 when projected from the left side as shown in FIG. 4. In this manner, when seen in a direction from the cylinder 11 to the intake 48 of the cleaner box 30, a part of the fuel tank 50 is formed to be interposed between the cleaner box 30 and the crankcase 14. Accordingly, it is possible to increase the capacity of the fuel tank 50 without increasing the overall size of the engine working machine 1.

### Second Exemplary Embodiment

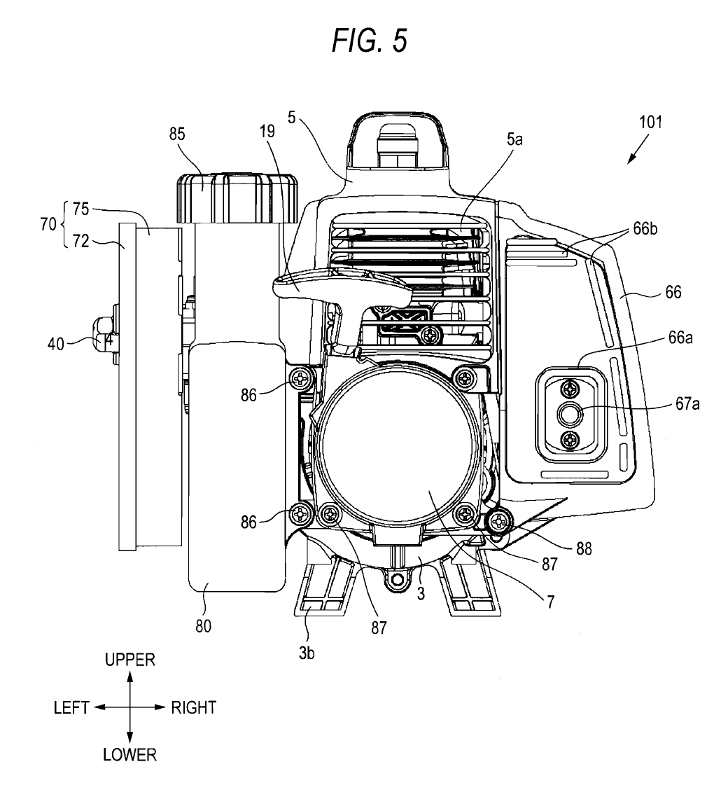

Next, a configuration of an engine working machine 101 according to a second exemplary embodiment of the present invention is described with reference with FIGS. 5 to 8. FIG. 5 is a rear view of the engine working machine 101 according to the second exemplary embodiment of the present invention. In the second exemplary embodiment, the fuel tank 80 is adapted to be provided on the lateral side rather than the lower side of the cylinder 11. Specifically, the fuel tank 80 is disposed at a space between an engine body and a cleaner box 70. The engine body is configured by the cylinder 11 and the crankcase 14. The fuel tank 80 is fixed to a tank fixing rib provided at the lateral side of the crankcase 14 by a fixing screw 86. The carburetor 20 is located at a space between the engine body and the cleaner box 70. Accordingly, in order to avoid the carburetor 20, the fuel tank 80 is formed to cover a lower side and a rear side of the carburetor 20. Since two legs 63b are formed at a lower volute case 63 to extend downward, the fuel tank 80 is positioned so as not to be brought into direct contact with the ground. As is easily understood from comparison between FIG. 5 and FIG. 3, according to the configuration of the second exemplary embodiment, the fuel tank 80 is not disposed below the crankcase 14 and thus it is possible to significantly reduce the overall height of the engine working machine 101. Further, since the fuel tank 80 is formed to cover a lower side and a rear side of the carburetor 20 in order to avoid the carburetor 20, it is possible to ensure a sufficient tank volume.

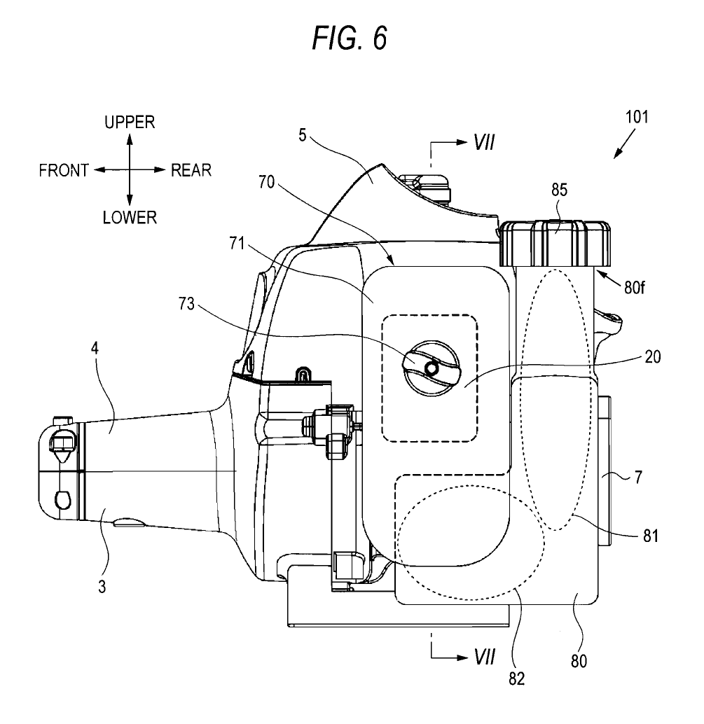

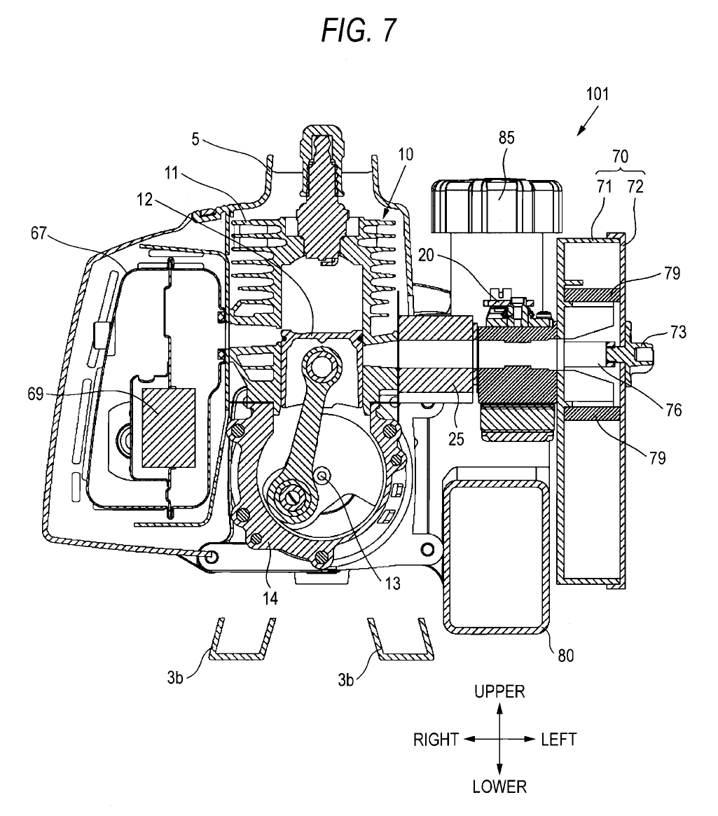

FIG. 6 is a side view of the engine working machine 101 according to the second exemplary embodiment of the present invention. The cleaner box 70 is provided at a left side surface of the engine working machine 101. The cleaner box 70 is configured by a cleaner body 71 (will be described later with reference to FIG. 7) and a cleaner cover 72. The cleaner cover 72 is fixed by a cleaner knob 73. The fuel tank 80 has a substantially L-shaped structure as seen from the suction direction into the cylinder 11 as shown in FIG. 6. A vertical part 81 of the L-shaped structure is disposed at a rear side of the carburetor, and a horizontal part 82 of the L-shaped structure is disposed below the carburetor. According thereto, it is possible to realize an engine which has a compact size in the vertical direction without arranging auxiliary devices below the crankcase 14. In this manner, the fuel tank 80 is disposed around the lower side and rear side of the carburetor 20. An opening 80f for introducing fuel extends to the vicinity of an upper end of the cylinder 11 and a fuel cap 85 is provided at the opening.

FIG. 7 is a longitudinal sectional view of the engine working machine 101 according to the second exemplary embodiment of the present invention, showing a cross-section view of VII-VII part of FIG. 6. It should be noted that the left-right direction in the D-D sectional view of FIG. 7 is reversed compared to the sectional view of FIG. 3. The second exemplary embodiment is similar to the first exemplary embodiment in that a muffler 67 is disposed at the engine body (the cylinder 11, the crankcase 14, etc.) and that the muffler 67 is larger in the vertical direction than the lateral direction. However, a lower end of the muffler 67 is positioned above the crankcase 14 and thus the muffler 67 of the second exemplary embodiment is different from the muffler 27 of the first exemplary embodiment which extends to the lower side than the crankcase 14. This is because the fuel tank 80 is not positioned at a lower side of the crankcase 14 and thus the distance from the crankcase 14 to a placement surface such as a floor surface is short, so that the muffler 67 does not extend to the lower side. Although a catalyst 69 is placed in the muffler 67, the shape of the muffler 67 including the arrangement position of the catalyst 69 may be optional.

The cleaner box 70 has a shape which is longer in the vertical direction. The size of the cleaner box 70 in the vertical direction is slightly shorter than that of the cleaner box 30 (FIG. 3) of the first exemplary embodiment, but a basic configuration thereof is the same as the first exemplary embodiment. That is, the cleaner box 70 is similar to the cleaner box 30 in that an upper end position of the cleaner box 70 is substantially the same as an upper end position of the cylinder 11, a lower end of the cleaner box 70 extends to the lower side than the crankcase 14 and the thickness of the cleaner box 70 in the lateral direction is thin. A cylindrical filter element 79 is provided inside the cleaner box 70. The shape of the filter element 79 may be selected arbitrarily. For example, the flat-shaped filter element shown in FIG. 2 may be used or the cylindrical filter element shown in FIG. 7 may be used. The cleaner cover 72 is fixed to the cleaner body 71 by fastening the cleaner knob 73 to a cleaner fixing plate 76. The cleaner fixing plate 76 is fastened together with the cleaner body 71, the carburetor 20 and the insulator 25 via the carburetor 20 and the insulator 25 by fixing screws.

The fuel tank 80 has a substantially rectangular sectional shape in the sectional view of FIG. 7 and effectively uses a space between the cleaner box 70 and the crankcase 14 as seen in the lateral direction. In addition, although not shown, a fuel hose is disposed at a space between the fuel tank 80 and the carburetor 20 and connects the carburetor 20 and the fuel tank 80.

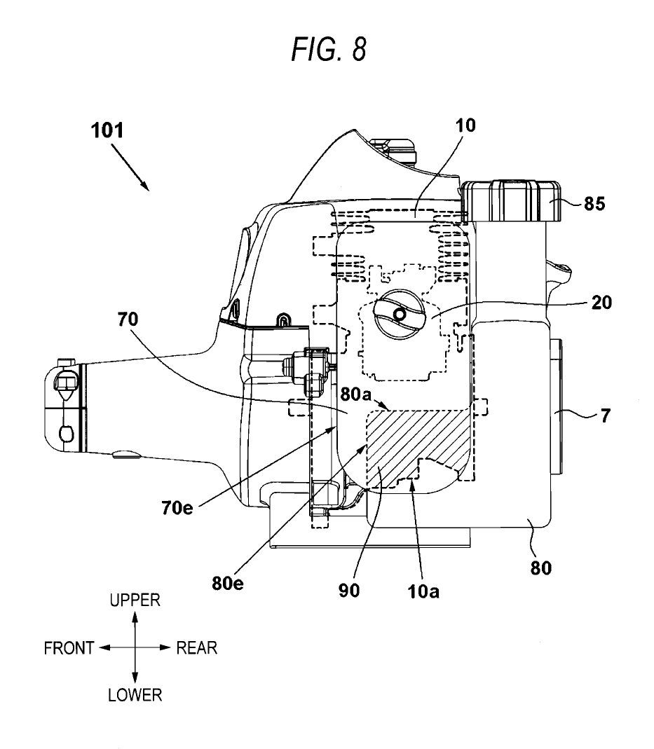

FIG. 8 is a side view of the engine working machine 101 according to the second exemplary embodiment of the present invention, explaining arrangement relationship among the engine body 10, the cleaner box 70 and the fuel tank 80. A front wall 80e of the fuel tank 80 extends to the vicinity of a front wall 70e of the cleaner box 70 and a front upper wall 80a of the fuel tank 80 is placed below the carburetor 20. The position of the engine body 10 is arranged as indicated by dotted line 10a and thus the engine body 10, the cleaner box 70 and the fuel tank 80 are arranged to be overlapped at a shaded portion 90 when projected from the left side as shown in FIG. 8. In this manner, the fuel tank 80 is formed to be interposed between the cleaner box 70 and the crankcase 14. Accordingly, it is possible to increase the capacity of the fuel tank 80 without increasing the overall size of the engine working machine 101.

The present invention has been described with reference to the exemplary embodiment. However, the present invention is not limited to the above-described exemplary embodiments, but a variety of changes can be made without departing from the scope of the invention.

For example, in the above-described exemplary embodiment, the engine working machine which is applied to the bush cutter has been described. However, the present invention is not limited to the bush cutter, but may be applied to the other engine working machines such as a chain saw, a blower and a lawnmower, or a general-purpose engine.

Further, in the above-described exemplary embodiments, two-cycle engine has been described in the above exemplary embodiment. However, the present invention is not limited to the two-cycle engine, but may be similarly applied to a four-cycle engine.

In addition, in the above-described embodiments, the volute case having a two-split shape divided in the vertical direction has been described. However, a case or frame for accommodating the engine of the engine working machine may have the other shapes.

What is claimed is:

1. An engine configured to operate a working machine, the engine comprising:
an engine body comprising a crankcase and a cylinder;
a carburetor connected to an inlet port of the cylinder;
an air cleaner connected to the carburetor to filter suction air;
a cleaner box configured to accommodate the air cleaner; and
a fuel tank configured to store fuel which is supplied to the cylinder,
wherein at least a part of the fuel tank is located between the cleaner box and the engine body.

2. The engine according to claim 1,
wherein the cylinder is arranged to extend in a vertical direction from the crankcase,
wherein the carburetor is attached to a side of the cylinder through an insulator, and
wherein the cleaner box has a flat shape which extends in the vertical direction and a tangential direction of the cylinder.

3. The engine according to claim 2,
wherein the fuel tank is disposed between the crankcase and the cleaner box when seen in a direction from the cylinder to an intake of the cleaner box.

4. The engine according to claim 3,
wherein an uppermost position of the fuel tank is located above a lowermost point of the crankcase and also above a lowermost point of the cleaner box, and
wherein a lowermost position of the fuel tank is located below the lowermost point of the cleaner box.

5. The engine according to claim 4, further comprising:
a muffler provided at a side of the engine body which is opposite to a side where the carburetor is provided,
wherein the muffler is configured to cover side surfaces of the cylinder and the crankcase and is sized to extend lower than the lowermost point of the crankcase, and
wherein most of the fuel tank is disposed at a space between the muffler and the cleaner box.

6. The engine according to claim 5,
wherein the lowermost point of the fuel tank is positioned below a lowermost point of the muffler.

7. The engine according to claim 3,
wherein the fuel tank has a substantially L-shaped structure as seen from a suction direction into the cylinder,
wherein a vertical part of the L-shaped structure is disposed at a rear side of the carburetor, and
wherein a horizontal part of the L-shaped structure is disposed below the carburetor.

8. An engine working machine comprising the engine according to claim 1.
